(19) United States
(12) Patent Application Publication
(10) Pub. No.: US 2006/0178453 A1
(43) Pub. Date: Aug. 10, 2006

(54) Lightweight base coating

(76) Inventor: Markus Bohler, Waterford Works, NJ (US)

Correspondence Address: CURATOLO SIDOTI CO., LPA, 24500 CENTER RIDGE ROAD, SUITE 280, CLEVELAND, OH, 44145, US

(21) Appl. No.: 11/055,375

(22) Filed: Feb. 10, 2005

(51) Int. Cl. C08J 9/32

(52) U.S. Cl. 523/218

(57) ABSTRACT

A lightweight base coat composition is provided that comprises a resin dispersion such as acrylic latex/binder, lightweight aggregate and optionally cementitious material to form a lightweight base coat composition. The reduction in weight is achieved by the replacement of fine sand aggregate with lightweight aggregate, which also provides additional insulation values. The improved insulation value allows darker colored finish compositions to be applied over the base coat without the risk of damaging (melting) the expanded polystyrene insulation (EPS) foam.

### BACKGROUND

Exterior insulation and finish systems (EIFS) are multi-layered exterior wall systems that are used on both commercial buildings and homes. EIFS typically comprises the following components: insulation board made of polystyrene or polyisocyanurate foam, which is secured to the exterior wall surface with a specially formulated adhesive and/or mechanical attachment; a durable water-resistance base coat, which is applied on top of the insulation and reinforced with fiberglass mesh for added strength; an attractive and durable finish coat typically using acrylic co-polymer technology, which is both color-fast and crack-resistant.

The base coat usually contains in addition to the co-polymer, an aggregate that is used to increase the durability and strength of the base coat composition. The base coat is typically supplied in 5-gallon pails that weigh about 60 pounds each. The heavy weight of the pails slows down the productivity of the workers during application of the base coat.

What is needed in the industry is a base coat composition that weighs significantly less than prior art compositions, but retains the properties of a base coat composition.

### SUMMARY

A lightweight base coat composition is provided which comprises lightweight aggregate, a resin dispersion, and optionally cementitious material.

A method is provided for preparing a lightweight base coat composition which comprises combining lightweight aggregate with a resin dispersion to form a mixture, and combining the mixture with cementitious material to produce a lightweight base coat composition.

A method is provided which comprises providing a lightweight base coat composition prepared by combining lightweight aggregate with a resin dispersion to form a mixture, combining the mixture with cementitious material to produce a lightweight base coat composition, and applying the lightweight base coat composition.

### BRIEF DESCRIPTION OF THE DRAWINGS

FIG. 1 is a graphical representation of the thickness at which the lightweight base coat composition shows signs of cracking.

FIGS. 2(a) and 2(b) are graphical representations showing the measure of the internal cohesion of the lightweight base coat composition.

FIG. 3 is a graphical representation of the measurement of adhesion in pounds per square inch.

FIG. 4 is a graphical representation of the temperature of the lightweight base coat composition in relation to the measurement of the surface temperature.

### DETAILED DESCRIPTION

A lightweight base coat composition is provided that comprises a resin dispersion such as acrylic latex/binder, lightweight aggregate and optionally cementitious material to form a lightweight base coat composition.

Multilayered exterior wall systems such as exterior insulation and finish systems (EIFS) are used extensively as the exterior wall surface of commercial and residential buildings. These systems, which include a substrate covered by one or more exterior finishing compositions, provide walls which are insulated and resistant to moisture. The multilayered exterior wall system may be prepared by covering a substrate such as plywood or gypsum board with a layer of insulation board, covering the insulation board with a layer of base coat embedded with a reinforcing mesh, and finishing with a topcoat.

A base coat is generally supplied in 5-gallon pails that weigh about 60 pounds. At the job site about 20 pounds of Base coat is mixed with about 30 pounds of Portland Cement Type I/II. A small amount of water, about 36 ounces, is used to adjust workability. The heavy weight of the pails slows the productivity of the workers during application of the base coat. The lightweight base coat composition provided reduces the weight of a 5-gallon pail by almost 50% from 60 pounds to about 40 pounds and provides improved application characteristics over the same coverage area. The lightweight base coat composition also improves the application characteristics by eliminating sagging and shrinkage. In addition, the lightweight base coat composition also provides increased insulating values.

The reduction in weight is achieved by the replacement of fine sand aggregate with microspheres, which have a density and weight that is less than sands such as silica sand (which is a density less than about 22 pounds per gallon). The lightweight aggregate also provides additional insulation value that reduces the temperature of the substrate below the lightweight base coat composition. The improved insulation value of the lightweight base coat composition allows darker colored finish compositions to be applied over the base coat without the risk of damaging (melting) the expanded polystyrene insulation (EPS) foam board portion of the EIFS system. Reduced weight improves productivity and safety at the job site, and reduces shipping costs.

The lightweight base coat composition retains the appearance and durability characteristics of standard base coats. Further, the light weight base coat composition applies easier, with less effort than a standard base coat.

Resin dispersions may comprise acrylic polymers which are aqueous dispersions of polymers, copolymers, or terpolymers of acrylic acid, acrylic acid ester, methacrylic acid, methacrylic acid ester, styrene acrylic acid, styrene acrylic acid ester, acrylonitrile, non-acrylic polymers such as polyvinyl acetate, styrene butadiene or mixtures thereof. Polymers that may be used can have greater or lesser flexibility depending upon the desired properties of the final finish product. A highly flexible latex will provide, for example, an elastomeric finish.

Lightweight aggregates are aggregate materials that have a density and weight that is less than those of sand, such as silica sand. The lightweight aggregate may be at least one of perlite, vermiculite, fly ash, silica spheres, microballoons, extendospheres, expanded clay, or pumice stone powder, or the like. In certain embodiments, the silica spheres are at least one of glass spheres or ceramic spheres, such as those available from SISCOR, Toronto, Canada.

Hydraulic cement is a material which reacts with water and hardens to produce a water-insoluble material. Examples of hydraulic cement include portland cement, magnesium phosphate cement, magnesium potassium phosphate cement, calcium aluminate cement, calcium sulfoaluminate cement or any other suitable hydraulic binder.

In addition to lightweight aggregate, resin dispersions and hydraulic cement, the lightweight base coat composition can also contain solvents, coalescing agents, thickening agents (rheology modifiers), defoamers, preservatives, flash rust inhibitors, fillers, pigments, or standard aggregates.

A solvent is a liquid and can include odorless mineral spirits and coalescents. Solvents aid in the development and formation of a film by the polymer in the curing process of the coating. They can be used in the manufacture of a coating to dissolve or disperse the film forming constituents. After application the solvent evaporates during drying and therefore does not become part of the dried film. A coalescing agent is a solvent with a high boiling point which, when added to a coating, aids in film formation via temporary plasticization (softening) of the liquid vehicle Coalescing agents may include diethylene-glycol ethyl ether, diethylene glycol ethyl ether acetate, hexylene glycol, and 2-butoxyethanol acetate, and the like. Suppliers of coalescents include Eastman Chemical—Perth Amboy, N.J., Dow Chemical—Midland, Mich. and Union Carbide—Houston, Tex.

Another solvent is odorless mineral spirits, which is a clear liquid solvent that is added to reduce stickiness in application. The addition of odorless mineral spirits lowers the surface tension of the coating which allows for a slower cure rate immediately after application to a surface.

A thickening agent, also referred to as a rheology modifier, is any material used to thicken a liquid and/or an additive used to thicken (increase viscosity) or modify the rheology of a coating. The thickening agent increases the viscosity of the lightweight base coat composition to provide a consistency which allows the application of a single thick film or multiple applications to build up a thick film on a vertical surface. The thickening agent prevents sagging of the thick film of the lightweight base coat composition on a vertical surface prior to set up or drying.

Thickening agents that may be used include alkali soluble emulsions, hydrophobically modified alkali soluble emulsions, alginates, hydroxyethyl cellulose, hydrophobically modified hydroxyethyl cellulose, hydrophobically modified polyurethanes, acrylamides, and hydrophobically modified polyacrylamides. In certain embodiments thickening agents may include alkali soluble emulsions, hydrophobically modified alkali soluble emulsions, and hydroxyethyl cellulose. Suppliers of thickening agents that can be used are Rohm and Haas—Philadelphia, Pa. and Union Carbide—Houston, Tex.

A defoamer is an additive used to reduce or eliminate foam formed in a coating or a coating constituent. Examples of defoamers are mineral oil based defoamers, such as silica filled polymethylsiloxane and NOPCO®NXZ produced by Henkel Corporation—Gulph Mills, Pa. Further examples of commercially available defoamers include products available from Crucible Chemical Company—Greenville, S.C.

A preservative may be a biocide which is used to prevent spoilage caused by bacterial growth in a coating that can cause odor or produce enzymes that can break down defoamers, coalescing agents, dispersants, stabilizers and thickening agents such as cellulosic thickeners used in aqueous paints and coatings. The addition of a biocide will contribute to preventing gas formation and foul odor, along with avoiding adverse effects on viscosity and stability. Examples of preservatives are amino alcohols, such as NUOSEPT®91 produced by International Specialty Products—Wayne, N.J., DOWICIL™ 75 and DOWICIL™ QK-20 manufactured by The Dow Chemical Company—Midland, Mich. Other companies providing commercially available biocides include Troy Chemical—Hackensack, N.J. and CreaNova—Piscataway, N.J. In certain embodiments, the preservative may be a fungicide or a mildewcide which may be included in the composition instead of or in addition to a biocide. The addition of a fungicide or mildewcide helps with resistance to fungal growth of the coating on the wall. Commercially available fungicides and mildewcides can be obtained from Troy Chemical—Hackensack, N.J., CreaNova—Piscataway, N.J. and Rohm and Haas—Philadelphia, Pa. Other biocides and fungicides include halogenated acetylene alcohols, diphenyl mercuric dodecenyl succinate, o-phenylphenol and its sodium salt, tri-chlorophenols and their sodium salts.

A flash rust inhibitor is an additive used to inhibit the corrosion that may occur during the drying process of a water-based coating. Examples of flash rust inhibitors generally used in the industry are sodium benzoate and sodium nitrite.

Fillers/pigments are finely ground, natural or synthetic, inorganic or organic, insoluble dispersed particles (such as powder) which, when dispersed in a liquid vehicle to make a coating, may provide, in addition to color, many of the properties of the coating such as opacity, hardness, durability, etc. Additionally, fillers may be added to lower the cost of the lightweight base coat composition. Fillers, also referred to as extenders, which may be used include clay, mica and wollastonite.

Clay fillers may include fine china clay/aluminum silicate fillers. For example, Kaofine™ is a coating clay that is available from the Thiele Kaolin Company of Sandersville, Ga. In addition, other commercially available clay fillers are available from Huber Engineered Materials—Atlanta, Ga. In certain embodiments coarse fillers are used and may be calcium carbonate or silica flour of a 200-mesh size (or average of 75 microns).

In certain embodiments colored or white pigments including mineral products which can be used as fillers and extenders may be used. Among the pigments that may be used are the various water insoluble organic and inorganic paint pigments which include, but are not limited to, iron oxides, titanium dioxide, zinc oxide, phthalocyanine blue and green, lead chromate, barium sulfate, zinc sulfide, silica, calcium carbonate, chrome green, iron blues and magnesium silicate (talc). Pigment dispersing agents, including but not limited to, tetrasodium pyrophosphate, lecithin, gum Arabic, sodium silicate, various water soluble soaps, aliphatic and aromatic sulfonates, the aliphatic sulfates, various polyethers and ether alcohol concentrates and the like, may be added to enhance the dispersion of the pigments.

Standard aggregates are inert solid mineral containing materials, such as natural sand, manufactured sand, gravel, and the like. Aggregates are solid granular particles which may impart surface texture to the dried layer of the exterior finishing composition. Further, the size of the aggregate may be used to determine the minimum applied thickness of the exterior finishing composition, especially for application by trowel. Suitable aggregates include sand and stone chips such as marble chips and granite chips.

The lightweight base coat composition may contain other components such as surfactants, emulsifiers; dispersants; curing agents such as organosilanes, epoxies, and isocyanates; plasticizers; fibers such as polyethylene fiber, wollastonite, cellulose fiber, and glass fiber; and bases such as sodium hydroxide, potassium hydroxide, 2-methyl-1-propanol, and ammonia.

In one embodiment the lightweight base coat composition comprises lightweight aggregate, resin dispersion, and optionally cementitious material, wherein in certain embodiments the lightweight aggregate is at least one of perlite, vermiculite, fly ash, silica spheres, microballoons, extendospheres, expanded clay, pumice stone powder or combinations thereof; and, in certain other embodiments, the silica spheres are at least one of glass spheres or ceramic spheres. Additionally, if present the hydraulic cement is optionally at least one of a portland cement, a magnesium phosphate cement, a magnesium potassium phosphate cement, a calcium aluminate cement, a calcium sulfoaluminate cement or combinations thereof. The resin dispersion may comprise acrylic polymers which are aqueous dispersions of polymers, copolymers, or terpolymers of acrylic acid, acrylic acid ester, methacrylic acid, methacrylic acid ester, styrene acrylic acid, styrene acrylic acid ester, acrylonitrile, non-acrylic polymers such as polyvinyl acetate, styrene butadiene or mixtures thereof.

The light weight base coat composition may be used in exterior and interior applications, such as multilayered exterior wall systems, including EIFS. The lightweight base coat composition may be applied onto horizontal surfaces as well as vertical surfaces.

Various methods may be used to apply the light weight base coat composition including troweling, spraying with air or airless hopper guns, brushing, rolling extruding, and the like.

A “paste unit” is defined as a viscosity measurement made with a Stormer viscometer using a spindle with two thin bars extending from a central shaft.

The samples were prepared using a ribbon blender or Schold mixer. To prepare the lightweight base composition, lightweight aggregate, resin and hydraulic cement were added to the blender/mixer followed by the components listed below. All samples tested were prepared using the basic light weight base coat formulation shown in Table 1 in which 50% by volume of silica sand was replaced with lightweight aggregate: 20 pounds of Silica Sand equals about 0.9 gallons and 20 pounds of lightweight aggregate equals about 3.6 gallons

TABLE 1

| | LW Base Coat | Standard Base Coat |
|---|---|---|
| Component | Wt (lb) | Wt (lb) |
| Water | 31.8 | 19.2 |
| Defoamer | 0.3 | 0.2 |
| Silica Spheres | 20 | |
| Acrylic Polymer | 20 | 15 |
| Silica Sand | 20 | 66 |

Wt (lb)—weight in pounds

To determine the thickness at which the lightweight base coat formulation would crack as compared to prior art base coat formulations, samples were prepared as shown in Table 1 and tested at different temperatures.

TABLE 2

| | |
|---|---|
| Standard Base Coat | LW Base Coat |

| | | |
|---|---|---|
| Sample | Temperature | Thickness Where Cracking Begins |

| | | | |
|---|---|---|---|
| S1 | 40° F. | 3.4 | 5.41 |
| S2 | 70° F. | 3.2 | 4.16 |
| S3 | 120° F. | 2.8 | 2.08 |

LW = light weight

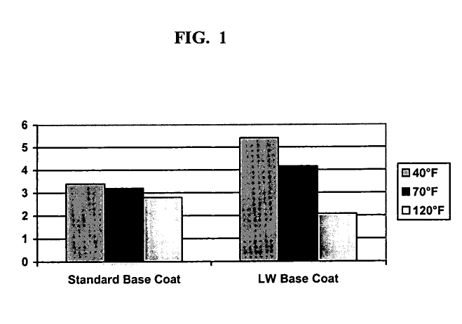

The results demonstrated that overall, the lightweight base coat can be applied thicker without cracking as compared to the standard base coat, as shown in FIG. 1. This can be very beneficial in covering the fasteners, which are used to mechanically attach the insulation foam boards to a building. During installation, the fasteners are attached in such a manner that they sit lower than the surface of the foam board. Base coat is often used to fill in the holes in the surface of the foam board caused by the fasteners, so that a smooth level substrate is available, for the base coat to be applied to the surface of the foam board. In deeper holes, the base coat filler tends to sag under its own weight, and a second application is often necessary.

Samples were prepared according to Table 1 and used to measure the internal cohesion of the light weight base coat using the Mesh Pull Through test. The internal cohesion is used to determine how well base coat compositions hold fiberglass mesh in place when embedded over EPS in an EIFS system. The base coat samples were spread on a foam board and the mesh embedded within an overlap of mesh. The samples were allowed to cure and soaked in water. After soaking, the overlapping mesh was then pulled to determine if the mesh would pull through the base coat sample.

TABLE 3

| | | | LW Base Coat | Std Base Coat |
|---|---|---|---|---|
| Sample | Dry | Wet | lbs/inch | lbs/inch |
| S4 | 40° F. | | 12.90 | 11.65 |
| S5 | | 40° F. | 5.38 | 4.96 |
| S6 | 70° F. | | 12.03 | 11.4 |
| S7 | | 70° F. | 3.35 | 4.1 |

lbs/inch = pounds per inch average
LW = light weight
Std = standard

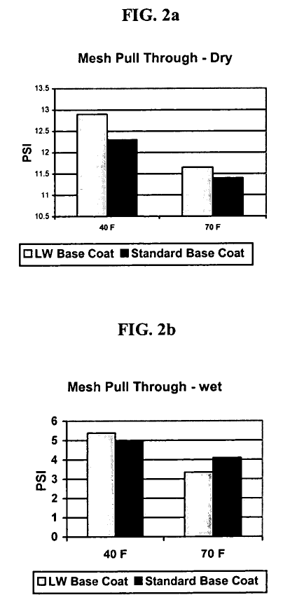

The lightweight base coat shows overall a slightly better performance than the standard base coat, as depictured in FIGS. 2(a) and 2(b), for internal cohesion based on the mesh pull-through test, demonstrating that the lightweight base coat composition has the strength to contain the mesh and support any outer layers that may be applied to its surface.

Samples were prepared according to Table 1 and used to measure the ultimate adhesion of the lightweight base coat. The test evaluates the ultimate strength of an adhesive between brick and any substrate. The base coat samples were applied to a brick surface and pressed to a larger brick. The base coat samples were allowed to cure and separation force was applied to the bricks, with adhesion of the base coat being measured.

TABLE 4

| | Ultimate Adhesion |
|---|---|
| Standard Base Coat | 176 PSI |
| LW Base Coat | 184 PSI |

LW = light weight

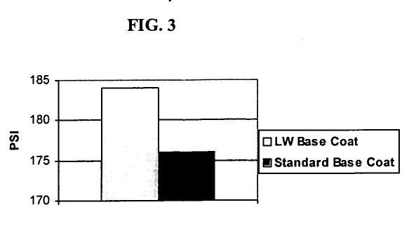

On average, the Lightweight Base Coat showed a 4.5% increase of adhesive strength over the standard base coat, as shown in FIG. 3.

For the water penetration test a 2″ wide 2 ft tall poly(vinyl chloride) PVC pipe (the PVC pipe is a standard Schedule 40 pipe) is attached with epoxy onto the lightweight base coat samples as prepared according to Table 1, so that the water at the base of the pipe is in contact with the sample. The pipe is filled with water and sealed to prevent evaporation, wherein the water level is monitored at specified intervals. The total water drop shows the difference in water level from the original level.

TABLE 5

| % Absorption | LW Base Coat | Standard Base Coat |
|---|---|---|
| Start | 0 | 0 |
| 4 hrs | 15.9% | 15.4% |
| 24 hrs | 19.0% | 18.1% |

LW = light weight

This test shows that the base coat does not allow water penetration even under pressure as observed during wind driven rain storms. The water absorption of the Lightweight Base Coat is slightly higher than that of the standard Base Coat, however it is still lower than the EIFS Industry Members Association (EIMA) standard of 25%.

The Base Coat Samples were mixed according to the proportions set forth in Table I above. After allowing the mixture to slack, the base coat is re-mixed to break the initial set. Using a trowel, the base coat is applied to a thickness of 3/16″, on a 1″ thick EPS board. Mesh is imbedded into the wet base coat. After application the base coat is allowed to cure at standard laboratory conditions for 28 days. 90 minutes prior to testing, the Mandrel Bend test samples were cut from the prepared board and placed in a freezer. After the specified time, the samples were removed from the freezer and immediately bent over specified diameter pipes. 5 samples for each diameter were used.

TABLE 6

| Diameter | Standard Base Coat | | | | LW Base Coat | | | |
|---|---|---|---|---|---|---|---|---|
| 4 inch | P | P | P | P | P | P | P | P |
| 2 inch | P | F | P | F | F | F | F | F |
| 1 inch | F | F | F | F | F | F | F | F |

P = Pass
F = Fail
LW = light weight

Table 6 shows that both the Standard and Lightweight Base Coat performed the same in determining the relative flexibility of the base coats. Both base coats passed at the 4 inch bend but neither base coat passed at the 2 inch bend with 50% of the standard samples failing.

Samples were prepared according to Table 1 and used to measure the temperature of the Base Coat. The surface temperature measurement was the temperature recorded on the base coat surface.

TABLE 7

| | | Surface | | Standard Base |
|---|---|---|---|---|
| Sample | | Temperature | LW Base Coat | Coat |
| S8 | 0 min | 73.5° F. | 76.6° F. | 76.6° F. |
| S9 | 5 min | 115° F. | 83.1° F. | 90.2° F. |
| S10 | 10 min | 121° F. | 85.7° F. | 91.9° F. |
| S11 | 15 min | 130° F. | 86.2° F. | 92.5° F. |
| S12 | 20 min | 126° F. | 85.5° F. | 91.7° F. |
| S13 | 25 min | 129.2° F. | 87.0° F. | 93.0° F. |
| S14 | 30 min | 126.6° F. | 87.8° F. | 94.6° F. |

LW = light weight

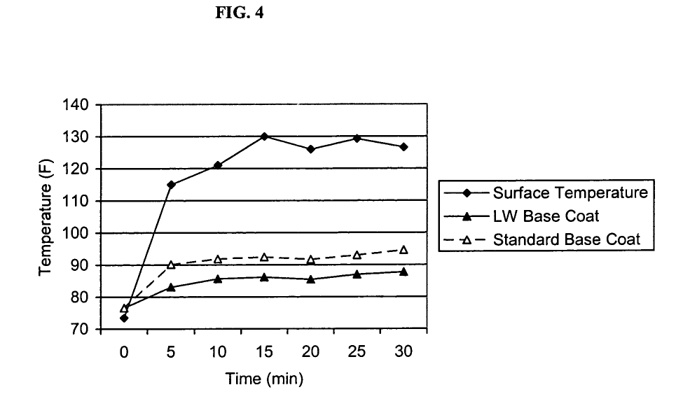

The average sub-temperature of the Lightweight Base Coat was 7% cooler than the Base Coat, as shown in FIG. 4, demonstrating increased insulating characteristics for the Lightweight Base Coat.

It will be understood that the embodiment(s) described herein is/are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

I Claim:

1. A lightweight base coat composition comprising:
a) lightweight aggregate;
b) resin dispersion; and optionally
c) cementitious material.

2. The composition of claim 1 wherein if present the cementitious material is hydraulic cement; said hydraulic cement optionally being at least one of a portland cement, a magnesium phosphate cement, a magnesium potassium phosphate cement, a calcium aluminate cement, a calcium sulfoaluminate cement or combinations thereof.

3. The composition of claim 1 wherein the lightweight aggregate is at least one of perlite, vermiculite, fly ash, silica spheres, microballoons, extendospheres, expanded clay, pumice stone powder or combinations thereof.

4. The composition of claim 3 wherein the silica spheres are at least one of glass spheres or ceramic spheres.

5. The composition of claim 1 wherein the resin dispersion comprises at least one of an acrylic polymer, a non-acrylic polymer or mixtures thereof, wherein the acrylic polymer if present is at least one of acrylic acid, acrylic acid ester, methacrylic acid, methacrylic acid ester, styrene acrylic acid, styrene acrylic acid ester, acrylonitrile or mixtures thereof and the non-acrylic polymer if present is at least one of polyvinyl acetate, styrene butadiene or mixtures thereof.

6. The composition of claim 1 further comprising at least one of emulsifiers, curing agents, dispersants, plasticizers, fibers, surfactants, thickening agents, coalescing agents, pH modifiers, defoamers, rust inhibitors, fillers, pigments, pigment dispersing agents, solvents, preservatives or aggregates.

7. A method for preparing a lightweight base coat composition comprising:
a) combining lightweight aggregate with a resin dispersion to form a mixture; and
b) combining the mixture with cementitious material to produce a lightweight base coat composition.

8. The method of claim 7 wherein the cementitious material is hydraulic cement; said hydraulic cement optionally being at least one of a portland cement, a magnesium phosphate cement, a magnesium potassium phosphate cement, a calcium aluminate cement, a calcium sulfoaluminate cement or combinations thereof.

9. The method of claim 7 wherein the lightweight aggregate is at least one of perlite, vermiculite, fly ash, silica spheres, microballoons, extendospheres, expanded clay, pumice stone powder or combinations thereof.

10. The method of claim 9 wherein the silica spheres are at least one of glass spheres or ceramic spheres.

11. The method of claim 7 wherein the resin dispersion comprises at least one of an acrylic polymer, a non-acrylic polymer or mixtures thereof, wherein the acrylic polymer if present is at least one of acrylic acid, acrylic acid ester, methacrylic acid, methacrylic acid ester, styrene acrylic acid, styrene acrylic acid ester, acrylonitrile or mixtures thereof and the non-acrylic polymer if present is at least one of polyvinyl acetate, styrene butadiene or mixtures thereof.

12. The method of claim 7 further comprising at least one of emulsifiers, curing agents, dispersants, plasticizers, fibers, surfactants, thickening agents, coalescing agents, pH modifiers, defoamers, rust inhibitors, fillers, pigments, pigment dispersing agents, solvents, preservatives or aggregates.

13. A method comprising providing a lightweight base coat composition prepared by:
a) combining lightweight aggregate with a resin dispersion to form a mixture;
b) combining the mixture with cementitious material to produce a lightweight base coat composition; and
c) applying the lightweight base coat composition.

14. The method of claim 13 wherein the cementitious material is hydraulic cement; said hydraulic cement optionally being at least one of a portland cement, a magnesium phosphate cement, a magnesium potassium phosphate cement, a calcium aluminate cement, a calcium sulfoaluminate cement or combinations thereof.

15. The method claim 13 wherein the lightweight aggregate is at least one of perlite, vermiculite, fly ash, silica spheres, microballoons, extendospheres, expanded clay, pumice stone powder or combinations thereof.

16. The method of claim 15 wherein the silica spheres are at least one of glass spheres or ceramic spheres.

17. The method of claim 13 wherein the resin dispersion comprises at least one of an acrylic polymer, a non-acrylic polymer or mixtures thereof, wherein the acrylic polymer if present is at least one of acrylic acid, acrylic acid ester, methacrylic acid, methacrylic acid ester, styrene acrylic acid, styrene acrylic acid ester, acrylonitrile or mixtures thereof and the non-acrylic polymer if present is at least one of polyvinyl acetate, styrene butadiene or mixtures thereof.

18. The method of claim 13 further comprising at least one of emulsifiers, curing agents, dispersants, plasticizers, fibers, surfactants, thickening agents, coalescing agents, pH modifiers, defoamers, rust inhibitors, fillers, pigments, pigment dispersing agents, solvents, preservatives or aggregates.
